(19) United States
(12) Patent Application Publication
(10) Pub. No.: US 2010/0279189 A1
(43) Pub. Date: Nov. 4, 2010

(54) Fuel cell system

(75) Inventors: Cheng Wang, Hsinchu (TW); Jin-Shu Huang, Hsinchu (TW); Ching-Po Lee, Hsinchu (TW); Nien-Hui Hsu, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsinchu (TW)

(21) Appl. No.: 12/003,877

(22) Filed: Jan. 3, 2008

(30) Foreign Application Priority Data
Mar. 9, 2007 (TW) 96108324

(51) Int. Cl. H01M 8/04

(52) U.S. Cl. 429/434

(57) ABSTRACT

A fuel cell system having uniform temperature field, includes at least one fuel cell stack. The fuel cell stack includes a housing, a fuel cell module, and an air guiding device. The housing defines an internal receiving space, and has an air outlet zone and at least two air inlet zones. The fuel cell module is disposed in the receiving space and includes a plurality of membrane electrode assemblies are disposed at intervals along a first sidewall toward a second sidewall on a plane of the receiving space of the housing. Each of the membrane electrode assemblies corresponds to at least one of the air inlet zones. The air guiding device is disposed on of the housing for generating airflows via the air inlet zones into the housing. The airflows flow along cathode surfaces of the membrane electrode assemblies and finally flow out of the housing via the air outlet zone.

### BACKGROUND OF THE INVENTION

1. Field of the Invention

The present invention relates to a fuel cell, and more particularly, to a fuel cell system having uniform temperature field.

2. Description of Related Art

A fuel cell is a power-generating unit that generates electrical energy through electrochemical reaction of fuel, such as hydrogen, methanol, etc., and air. The most common fuel cells may be generally divided into a proton exchange membrane fuel cell, or polymer electrolyte membrane fuel cell (PEMFC or PEM), and a direct methanol fuel cell (DMFC).

The direct methanol fuel cell includes a membrane electrode assembly (MEA) having an anode surface and a cathode surface, and uses oxygen as a cathode fuel thereof The oxygen may be obtained from a pure oxygen source or ambient air. An air guiding device, such as a pump or a fan, is used to induce air to the cathode surface. In addition to the supply of oxygen required by the reaction in the fuel cell, the air guiding device also functions to carry away heat energy produced during the reaction in the fuel cell.

FIGS. 1 and 2 are side and top views, respectively, of a planar type fuel cell stack 100, which includes a housing 1, an air guiding device 2, and a plurality of fuel cell modules 3. The housing 1 includes an air outlet zone 11 and an air inlet zone 12, which are provided on two opposite sidewalls of the housing 1.

The air guiding device 2, which may be an axial-flow fan, is mounted to the air outlet zone 11. The fuel cell modules 3 are configured as a flat plate each, and are parallelly spaced by a predetermined distance. Each of fuel cell modules 3 includes a plurality of membrane electrode assemblies 31a, 31b, 31c serially arranged and spaced in a direction I, and are positioned by a frame 33. The membrane electrode assemblies 31a, 31b, and 31c respectively have a cathode surface 32 exposed to a receiving space in the housing 1. The air guiding device 2 has a rotary shaft, an axis of which is extended in a direction in parallel with the direction I.

When the air guiding device 2 operates, an inlet airflow AI is induced into the receiving space 13 of the housing via the air inlet zone 12 to flow in the direction I. The inlet airflow AI sequentially flows along the cathode surfaces 32 of the membrane electrode assemblies 31a, 31b, and 31c, and then flows out of the housing 1 via the air outlet zone 11 as an outlet airflow AO.

The fuel cell has higher power-generating performance when the membrane electrode assemblies have a higher temperature. However, when the membrane electrode assemblies in the same fuel cell system have excessively high temperature differences among them to cause a non-uniform temperature field in the fuel cell system, the operating efficiency and the usable life of the membrane electrode assemblies are adversely affected.

In the conventional planar type fuel cell stack 100, the air guiding device 2 is mounted to one of two opposite sidewalls of the housing 1, and the inlet airflow AI is caused to sequentially flow through the membrane electrode assemblies 31a, 31b, 31c only in the direction I. When the one-directional inlet airflow AI flows from an upstream area near the air inlet zone 12 along the cathode surfaces of the membrane electrode assemblies to a downstream area near the air outlet zone 11, heat carried by the inlet airflow AI accumulates, making the airflow AI and accordingly, the membrane electrode assemblies 31b, 31c at the downstream area have temperatures higher than that of the membrane electrode assemblies 31a at the upstream area. That is, the membrane electrode assemblies 31a, 31b, and 31c have different temperature fields, and accordingly, different power generation capacities as well as different power-generating densities per unit area. This condition is highly disadvantageous to the electrical property and power generating performance of the fuel cell, and would result in membrane electrode assemblies 31a, 31b, 31c having different usable life periods.

In the fuel cell stack 100, the anode fuel, such as methanol, for the membrane electrode assemblies reacts with a catalyst on the surfaces of the membrane electrode assemblies and is dissociated to produce hydrogen ions and electrons. The hydrogen ions and electrons produced at the anode in the reaction further react with oxygen at the cathode to produce water, which is carried away from the fuel cell stack 100 by the outlet airflow AO produced by the air guiding device 2 at the air outlet zone 11 of the housing 1. When the reactions occur at membrane electrode assemblies having non-uniform temperature fields, the closer the airflow is to the downstream area in the housing 1, the higher the quantity of water is carried by the airflow, making the cathode product at the downstream area in the housing 1 to become highly saturated and more difficult to discharge, and therefore resulting in the problem of flooding in the housing 1 to reduce the usable life of the membrane electrode assemblies.

The conventional planar type fuel cell stack has another problem of having excessive flow resistance. Therefore, the air guiding device has to constantly operate at a relatively high rotary speed, which not only produces louder noise, but also increases the power load of the fuel cell system.

### SUMMARY OF THE INVENTION

An object of the present invention is to provide a fuel cell system having a uniform temperature field, overcoming the problem of flooding, and having lower flow resistance.

To achieve the above objects, in accordance with the present invention, a fuel cell system is provided. The fuel cell system, which is capable to maintain a uniform temperature distribution throughout the whole system, comprises at least one fuel cell stack. The fuel cell stack includes a housing, at least one fuel cell module, and an air guiding device. The housing defines an internal receiving space, and has an air outlet zone and at least two air inlet zones. The fuel cell module is disposed in the receiving space and includes a plurality of membrane electrode assemblies disposed at intervals along a first sidewall toward a second sidewall on a plane of the receiving space of the housing. Each of the membrane electrode assemblies corresponds to at least one of the air inlet zones. The air guiding device is disposed on the housing for generating airflows via the air inlet zones into the housing, which flow along cathode surfaces of the membrane electrode assemblies and finally flow out of the housing via the air outlet zone.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a side view of a conventional planar stack type fuel cell system;

FIG. 2 is a top view of the fuel cell system of FIG. 1;

FIG. 3 is a perspective view of a fuel cell system according to a first embodiment of the present invention;

FIG. 4 is an exploded view of the first embodiment of the present invention in FIG. 3;

FIG. 5 is a top view of the fuel cell system of the first embodiment of the present invention in FIG. 4;

FIG. 6 is a side view showing airflows in the fuel cell system according to the first embodiment of the present invention;

FIGS. 7 to 9 are side views showing airflows in three variations of the first embodiment of the present invention;

FIG. 10 is a top view of a fuel cell system having three membrane electrode assemblies of the present invention;

FIG. 11 is a side view of the fuel cell system in FIG. 10;

FIG. 12 is an exploded perspective view of another fuel cell system of the present invention; and

FIG. 13 is a side view of a fuel cell system according to a second embodiment of the present invention.

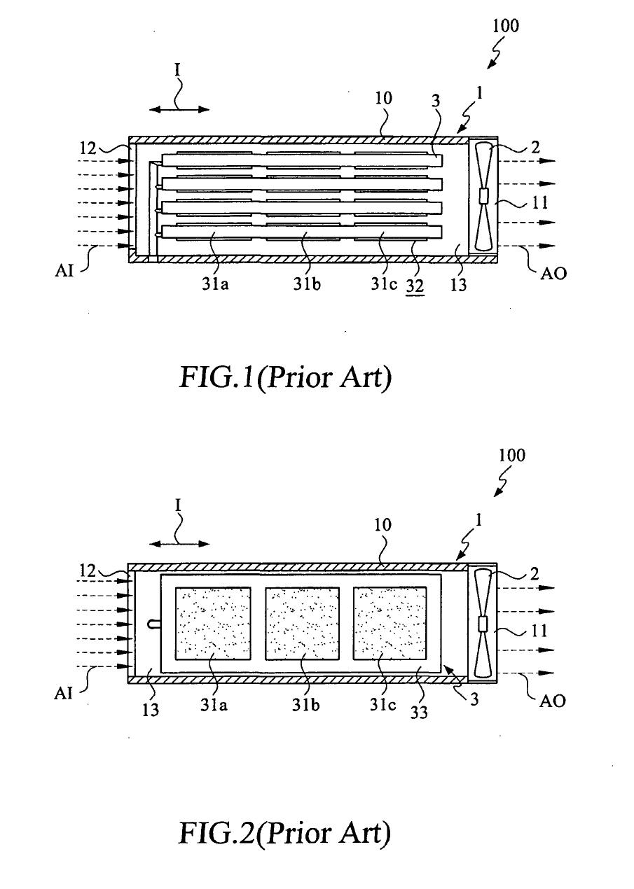

### DETAILED DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to”. “B” component or one or more additional components is between “A” component and “B” component. Accordingly, the drawings and descriptions will be regarded as illustrative in nature and not as restrictive.

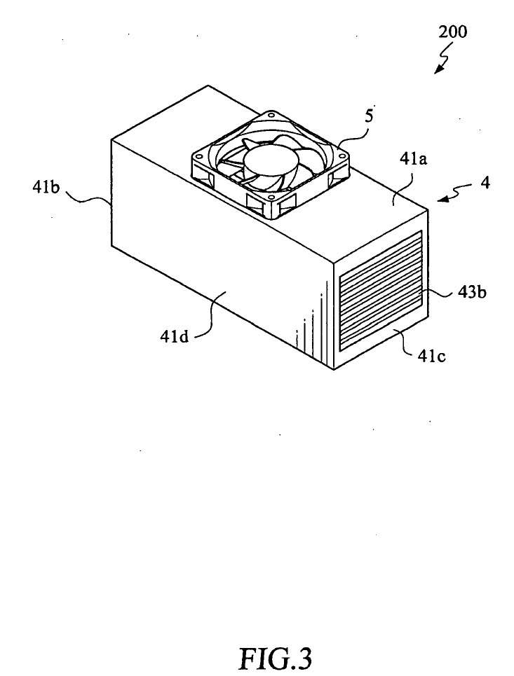

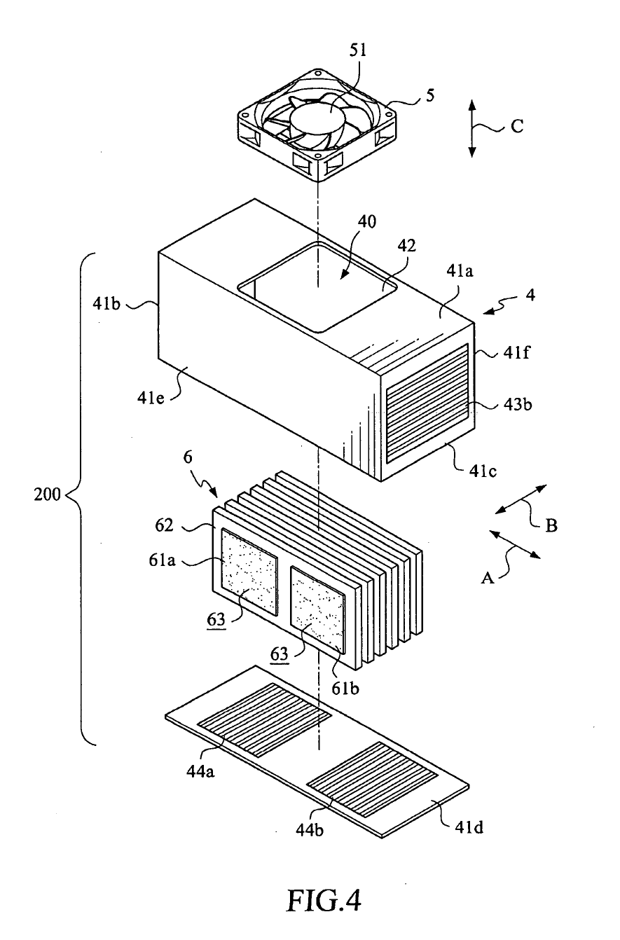

Please refer to FIGS. 3 and 4. A fuel cell system of a first embodiment includes a fuel cell stack 200, which has a housing 4, an air guiding device 5, and at least one fuel cell module 6. In the illustrated first embodiment, a plurality of the fuel cell modules 6 are shown.

The housing 4 defines an inner receiving space 40, and has an air outlet zone 42, at least two air inlet zones 43a, 43b, 44a, 44b, a first wall 41a, a second wall 41d opposite to the first wall 41a, and a first, a second, a third, and a fourth sidewalls 41b, 41c, 41e, 41f connected to the first and the second walls 41a, 42d. The first sidewall 41b is opposite to the second sidewall 41c, and the third sidewall 41e is opposite to the fourth sidewall 41f. The first and second walls 41a, 41d together with the first to the fourth sidewalls 41b, 41c, 41e, 41f define and enclose the inner receiving space 40.

In the first embodiment, the air outlet zone 42 is disposed on the first wall 41a, and there are four air inlet zones 43a, 43b, 44a, 44b located on at least one of the first sidewall 41b, the second sidewall 41c, and the second wall 41d. In the illustrated first embodiment, the air inlet zone 43a is located on the first sidewall 41b, the air inlet zone 43b on the second sidewall 41c, and the air inlet zones 44a, 44b on the second wall 41d.

The fuel cell modules 6 are disposed at intervals along the third sidewall 41e toward the fourth sidewall 41f in the inner receiving space 40 of the housing 4. A direction between the third sidewall 41e and the fourth sidewall 41f is defined as a second direction indicated by the two-headed arrow “B”, and an air passage is formed between any two adjacent fuel cell modules 6.

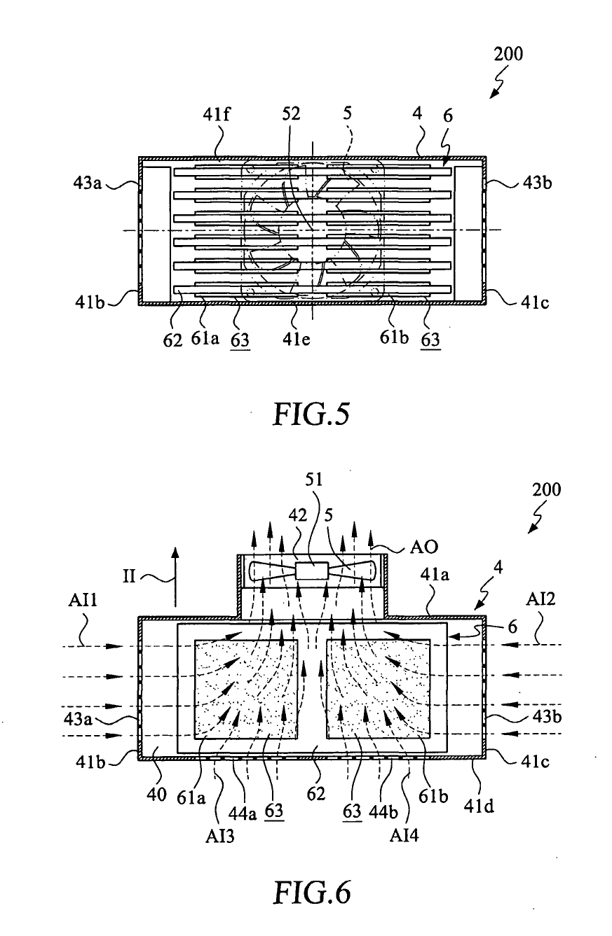

Each of the fuel cell modules 6 includes a plurality of membrane electrode assemblies 61a, 61b and a frame 62 for positioning the membrane electrode assemblies 61a, 61b. Each of the membrane electrode assemblies 61a, 61b is disposed at intervals along the first sidewall 41b toward the second sidewall 41c on a plane of the receiving space of the housing. A direction between the first sidewall 41b and the second sidewall 41c is defined as a first direction indicated by the two-headed arrow “A”. Each of the membrane electrode assemblies 61a, 61b respectively has a cathode surface 63 exposed to the receiving space 40 of the housing 4, and corresponds to at least one of the air inlet zones. In the illustrated first embodiment of the present invention, two membrane electrode assemblies 61a, 61b are shown. The air inlet zones 43a, 44a are disposed corresponding to the membrane electrode assembly 61a, and the air inlet zones 43b, 44b are disposed corresponding to the membrane electrode assembly 61b, as shown in FIG. 6. More specifically, the air inlet zone 43a and the air inlet zone 44a are located near one side and a bottom of the membrane electrode assembly 61a farther away from the other membrane electrode assembly 61b respectively. Similarly, the air inlet zone 43b and the air inlet zone 44b are located near one side and a bottom of the membrane electrode assembly 61b farther away from the other membrane electrode assembly 61a respectively.

The air guiding device 5 is disposed on the housing 4 for generating airflows. The air guiding device 5 includes a rotary shaft 51, and an axis of the rotary shaft 51 is extended in a direction indicated by the two-headed arrow “C” to be perpendicular to the first and second directions “A” and “B”. Preferably, a center 52 of the rotary shaft 51 of the air guiding device 5 is located at a geometrical center of the first wall 41a, as shown in FIG. 5. The air guiding device 5 may be an axial-flow fan, a pump, an air blower, or any other functionally equivalent device for generating airflows. In the illustrated first embodiment, the air guiding device 5 is an axial-flow exhaust fan and disposed on the air outlet zone 42. However, it is understood the air guiding device 5 may be other types of fans and mounted to other positions on the housing 4. For example, the air guiding device 5 may be an axial-flow suction fan disposed on any one of the air inlet zones 43a, 43b, 44a, 44b.

Please refer to FIG. 6. When the air guiding device 5 is started to operate, inlet airflows AIL AI2, AI3, AI4 are induced into the receiving space 40 of the housing 4 via the air inlet zones 43a, 43b, 44a, 44b. The inlet airflows AI1, AI3 flow along the cathode surface 63 each of the membrane electrode assemblies 61a, and the inlet airflows AI2, AI4 flow along the cathode surface 63 of each of the membrane electrode assemblies 61b, and all the inlet airflows AI1, AI2, AI3, AI4 finally flow in a direction II toward the air outlet zone 42 at the first wall 41a of the housing 4 to guide out an outlet airflow AO. Therefore, all the membrane electrode assemblies 61a, 61b in the receiving space 40 of the housing 4 have the same temperature and humidity.

In the present invention, the air guiding device 5 is so positioned that its rotary shaft 51 has the axis direction C perpendicular to the first direction A, and each of the membrane electrode assemblies 61a, 61b corresponds to at least one of the air inlet zones. Therefore, when the air guiding device 5 operates to generate airflows, it is possible for all the membrane electrode assemblies 61a, 61b to be cooled at the same time, and a symmetric cool airflow field is formed in the fuel cell system. As a result, all the membrane electrode assemblies 61a, 61b may have the same temperature, humidity, and heat dissipation. Accordingly, all the membrane electrode assemblies have the same power-generating efficiency per unit area and uniform service life, enabling the whole fuel cell stack to have longer usable life.

With the above arrangements, the flow path of the airflows in the receiving space 40 of the fuel cell system of the present invention is shortened to only one half of that in the conventional fuel cell system 100. This allows the airflows in the fuel cell stack 200 to have lower flow resistance. Moreover, when the fuel cell stack 200 operates under general voltage level, the amount of the airflows flown through the fuel cell modules 6 is even higher than that in the fuel cell stack 100 of prior art. The increased amount of airflows also allows the air guiding device 5 to operate at a lower rotational speed to reduce possible noise.

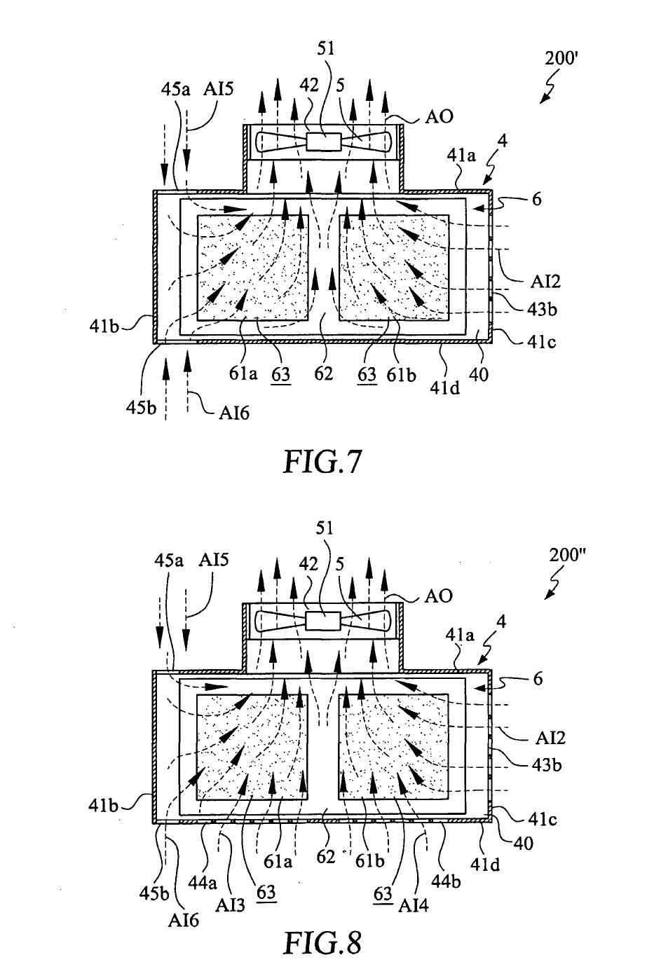

The air inlet zones may be changed to different positions on the housing 4 according to actual needs. For example, FIG. 7 shows a fuel cell stack 200′, which is a first variation of the first embodiment of the present invention, and has three air inlet zones provided on the housing 4, namely, an air inlet zone 43b provided on the second sidewall 41c of the housing 4, and two air inlet zones 45a, 45b provided on the first wall 41a and the second wall 41d, respectively, of the housing 4 near the first sidewall 41b. When the air guiding device 5 is started to operate, inlet airflows AI2, AI5, AI6 are generated and induced into the receiving space 40 of the housing 4 via the air inlet zones 43b, 45a, 45b, respectively, to flow along the cathode surfaces 63 of the membrane electrode assemblies 61a, 61b and produce a substantially laterally symmetrical flow field in the housing 4 before they finally form an outlet airflow AO to flow out of the housing 4 via the air outlet zone 42.

FIG. 8 shows a fuel cell stack 200″, which is a second variation of the first embodiment of the present invention and has five air inlet zones provided on the housing 4, namely, an air inlet zone 43b provided on the second sidewall 41c of the housing 4, two air inlet zones 45a, 45b provided on the first wall 41a and the second wall 41d, respectively, of the housing 4 near the first sidewall 41b, and another two air inlet zones 44a, 44b provided on the second wall 41d of the housing 4. The air inlet zones 44a, 44b are located on the second wall 41d corresponding to the membrane electrode assemblies 61a, 61b, respectively. When the air guiding device 5 is started to operate, inlet airflows AI2, AI5, AI6, AI3, AI4 are generated and induced into the receiving space 40 of the housing 4 via the air inlet zones 43b, 45a, 45b, 44a, 44b, respectively, to form a substantially laterally symmetrical flow field, enabling the membrane electrode assemblies 61a, 61b to have a uniform temperature field.

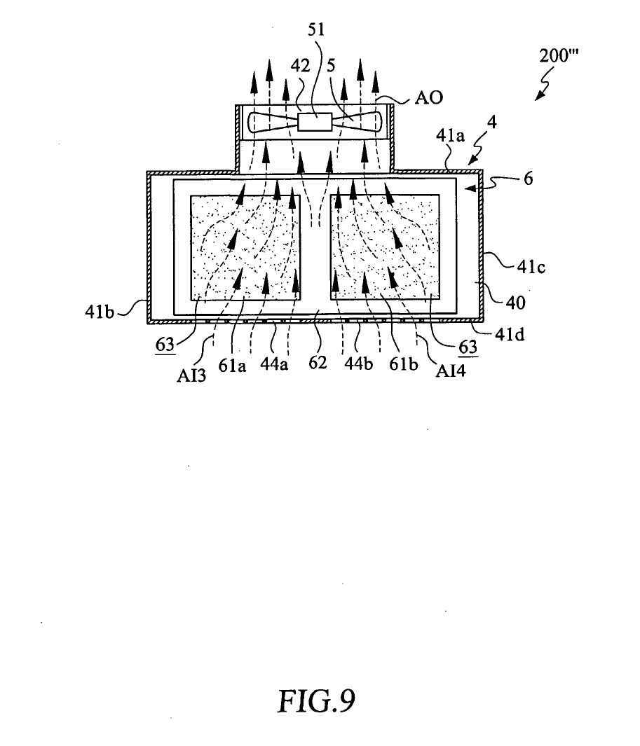

FIG. 9 shows a fuel cell stack 200′″, which is a third variation of the first embodiment of the present invention and has two air inlet zones 44a, 44b provided on the second wall 41d of the housing 4 corresponding to the membrane electrode assemblies 61a, 61b, respectively. When the air guiding device 5 is started to operate, inlet airflows AI3, AI4 are generated and induced into the receiving space 40 of the housing 4 via the air inlet zones 44a, 44b, respectively, to flow along the cathode surfaces 63 of the membrane electrode assemblies 61a, 61b before they finally form an outlet airflow AO to flow out of the housing 4 via the air outlet zone 42.

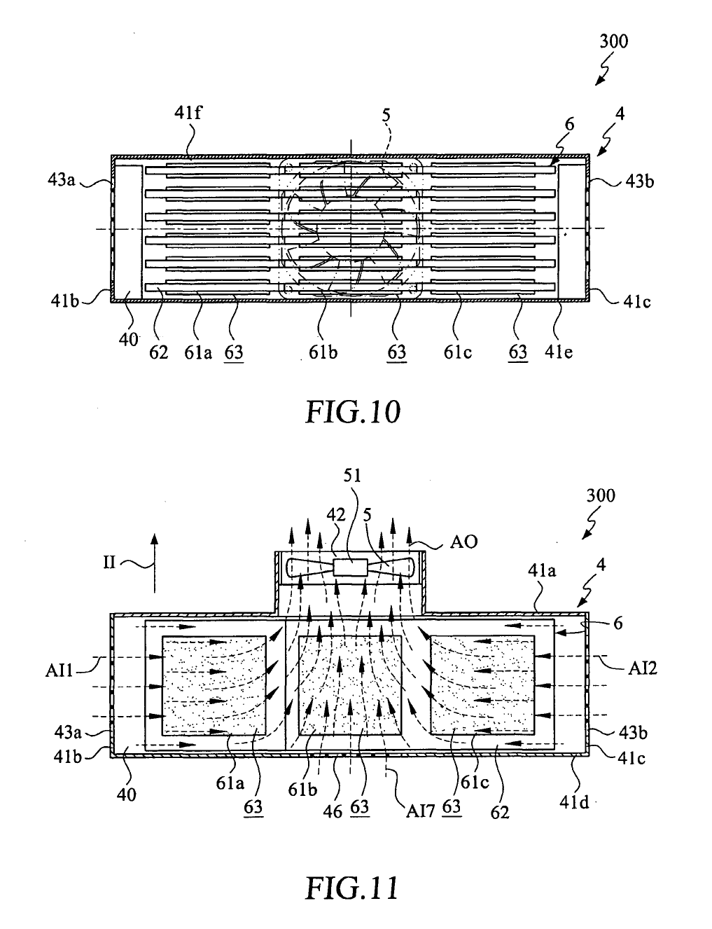

The number of membrane electrode assemblies included in each of the fuel cell modules in a fuel cell stack may be adjusted according to a desired power generation capacity. Please refer to FIGS. 10 and 11. A fuel cell stack 300 according to a further variation of the first embodiment of the present invention is shown. Each of the fuel cell modules 6 in the fuel cell stack 300 has three membrane electrode assemblies 61a, 61b, and 61c. The second wall 41d of the housing 4 is provided at a central area with an air inlet zone 46 corresponding to the membrane electrode assemblies 61b, so that an inlet airflow AI7 may be induced into the receiving space 40 via the air inlet zone 46. Another air inlet zone 43a is provided on the first sidewall 41b of the housing 4 to correspond to the membrane electrode assemblies 61a, so that an inlet airflow AI1 is induced into the receiving space 40 via the air inlet zone 43a. A further air inlet zone 43b is provided on the second sidewall 41c of the housing 4 to correspond to the membrane electrode assemblies 61c, so that an inlet airflow AI2 is induced into the receiving space 40 via the air inlet zone 43b. When the air guiding device 5 is started to operate, inlet airflows AI1, AI2, AI7 are generated and induced into the receiving space 40 of the housing 4 via the air inlet zones 43a, 43b, 46, respectively, to flow along the cathode surfaces 63 of the membrane electrode assemblies 61a, 61b, 61c and finally form an outlet airflow AO to flow out of the housing 4 via the air outlet zone 42. This arrangement also enables the plurality of membrane electrode assemblies 61a, 61b, 61c to have a uniform temperature field.

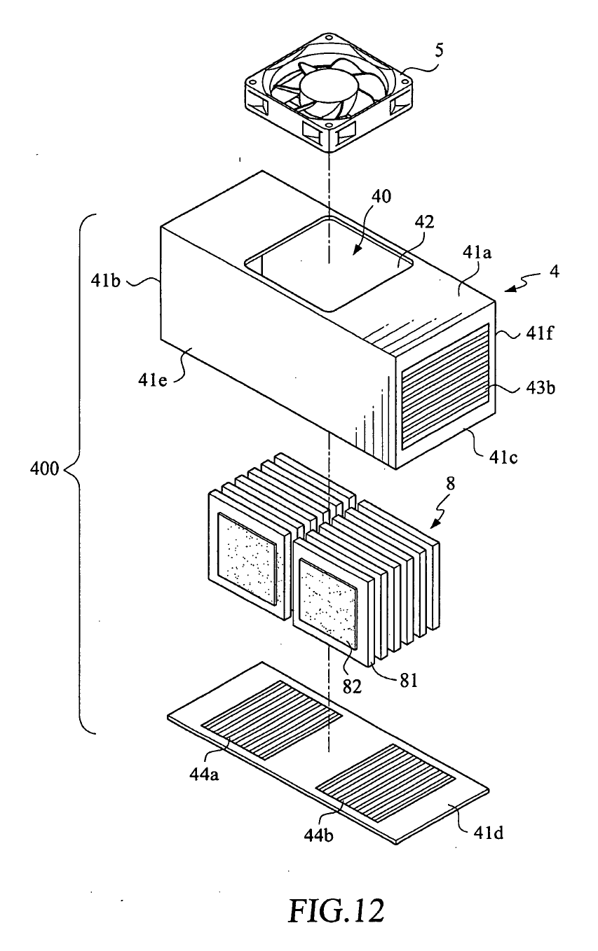

The fuel cell systems shown in FIGS. 3 through 11 are of the typical planar type fuel cell systems, and each of the fuel cell modules thereof includes a plurality of membrane electrode assemblies disposed at intervals on the same plane, and a frame for holding the plurality of membrane electrode assemblies in place. However, the fuel cell modules in the fuel cell system of the present invention may have a structure different from that shown in FIGS. 3 through 11. Please refer to FIG. 12 that shows a fuel cell stack 400 generally structurally similar to the first embodiment of the present invention. However, the fuel cell stack 400 is different from the first embodiment in that it includes a plurality of fuel cell modules 8, each of the fuel cell modules 8 includes a plurality of fuel cell units 81 disposed at intervals in the receiving space 40 of the housing 4. And, each of the fuel cell units 81 includes a membrane electrode assembly 82.

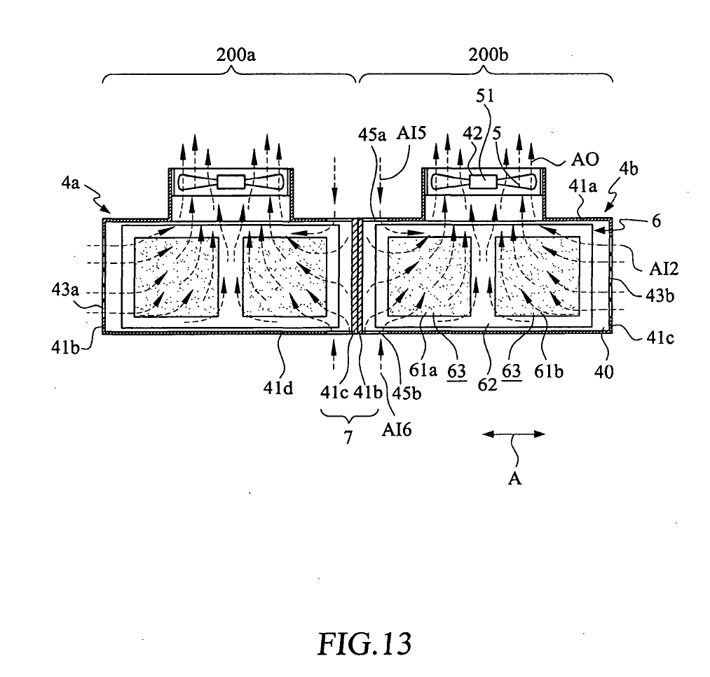

Please refer to FIG. 13 that is a second embodiment of the present invention, components or elements that are the same as or similar to those in the first embodiment are denoted by the same reference numerals as those in FIGS. 3 to 12. The second embodiment is different from the first embodiment in that it includes a plurality of adjoining fuel cell stacks 200a, 200b connected to one another in the first direction A. A partition wall 7 is existed between any two adjacent fuel cell stacks 200a, 200b, so that cooling airflows in the two fuel cell stacks are isolated from one another. In the illustrated second embodiment, the partition wall 7 is formed by associating the second sidewall 41c of the fuel cell stack 200a with the first sidewall 41b of the fuel cell stack 200b. The fuel cell stacks 200a, 200b are independently provided on respective housing 4a, 4b at the first wall 41a thereof with an air outlet zone 42 and an air guiding device 5. The fuel cell stacks 200a, 200b may be configured as any one of the fuel cell stacks 200, 200′, 200″, 200″′, 300, and 400. In the illustrated second embodiment, the fuel cell stacks 200a, 200b have a structure similar to the fuel cell stack 200′ shown in FIG. 7. When the air guiding device 5 of the fuel cell stack 200b is started to operate, inlet airflows AI2, AI5, AI6 are generated and induced into the receiving space 40 of the housing 4b via the air inlet zones 43b, 45a, 45b, respectively, to flow along the cathode surfaces 63 of the membrane electrode assemblies 61a, 61b and produce a symmetrical flow field before they finally form an outlet airflow AO to flow out of the housing 4b via the air outlet zone 42. Similarly, a symmetrical flow field is formed in the housing 4a when the air guiding device 5 of the fuel cell stack 200a is started to operate.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell system, comprising at least one fuel cell stack, and the fuel cell stack comprising:
a housing internally defining a receiving space, and having a first wall, a second wall opposite to the first wall, a first sidewall and a second sidewall opposite to the first sidewall, the first sidewall and the second sidewall being connected to the first wall and the second wall, at least two air inlet zones, and at least one air outlet zone disposed on the first wall;
at least one fuel cell module disposed in the receiving space of the housing, the fuel cell module including a plurality of membrane electrode assemblies, each of the membrane electrode assemblies disposed at intervals along the first sidewall toward the second sidewall on a plane of the receiving space of the housing and having a cathode surface exposed to the receiving space of the housing, being located corresponding to at least one of the air inlet zones, each of the membrane electrode assemblies having a cathode surface exposed to the receiving space of the housing; and
an air guiding device disposed on the housing for generating airflows, the airflows being induced into the receiving space of the housing via the air inlet zones to flow along each cathode surface of each of the membrane electrode assemblies in the fuel cell module, and being finally guided out of the housing via the air outlet zone.

2. The fuel cell system as claimed in claim 1, wherein the at least one fuel cell module includes a plurality of fuel cell modules, the housing further includes a third sidewall and a fourth sidewall opposite to the fourth sidewall, the third sidewall and the fourth sidewall are connected to the first and the second wall, and the fuel cell modules are disposed at intervals along the third sidewall toward the fourth sidewall in the receiving space of the housing.

3. The fuel cell system as claimed in claim 2, wherein a direction extended between the third sidewall and the fourth sidewall is defined as a second direction, the air guiding device includes a rotary shaft, and an axis of the rotary shaft is extended in a direction perpendicular to the second direction.

4. The fuel cell system as claimed in claim 1, wherein the air guiding device is disposed on the air outlet zone of the housing, and is an axial-flow fan.

5. The fuel cell system as claimed in claim 1, wherein a direction extended between the first sidewall and the second sidewall is defined as a first direction, the air guiding device includes a rotary shaft, and an axis of the rotary shaft is extended in a direction perpendicular to the first direction.

6. The fuel cell system as claimed in claim 1, wherein the air inlet zones are located on at least one of the first sidewall, the second sidewall, and the second wall.

7. The fuel cell system as claimed in claim 1, wherein the fuel cell module further includes a frame for positioning the membrane electrode assemblies.

8. The fuel cell system as claimed in claim 1, wherein the fuel cell module includes a plurality of fuel cell units disposed at intervals in the receiving space of the housing, and each of the fuel cell units has one of the membrane electrode assemblies.

9. The fuel cell system as claimed in claim 1, wherein the at least one fuel cell stack includes a plurality of fuel cell stacks adjoined and connected to one another with a partition wall formed between any two adjacent fuel cell stacks.

10. The fuel cell system as claimed in claim 1, wherein the air guiding device is disposed on the first wall of the housing and includes a rotary shaft, and a center of the rotary shaft is located at a geometrical center of the first wall.
